(19) United States
(12) Patent Application Publication
(10) Pub. No.: US 2026/0030418 A1
(43) Pub. Date: Jan. 29, 2026

(54) METHOD FOR SIMULATING THE EVOLUTION OF A RESERVOIR DUE TO DISSOLUTION

(71) Applicant: TotalEnergies OneTech, Courbevoie (FR)

(72) Inventors: Charles Danquigny, Pau (FR); Gérard Massonnat, Pau (FR); Jérémy Ruiu, Pau (FR); Lucie Dal Soglio, Pau (FR); Cédric Gal, Pau (FR)

(21) Appl. No.: 18/572,703

(22) PCT Filed: Apr. 18, 2023
(86) PCT No.: PCT/IB2023/000220

§ 371 Date: Dec. 20, 2023

(51) Int. Cl. G06F 30/28; G01V 20/00; G06F 113/08

(52) U.S. Cl. CPC G06F 30/28; G01V 20/00; G06F 2113/08

(57) ABSTRACT

A computer-implemented method for simulating the evolution of a reservoir due to dissolution within the reservoir includes representing the reservoir by a graph model comprising a plurality of nodes and connections between the nodes, wherein each node is associated with at least one geological parameter, simulating dissolution induced by a fluid flowing through the reservoir during a determined time period, wherein said simulating comprises computing updated values of geological parameters assigned to the nodes of the graph model as a consequence of said dissolution, and updating a topology of the graph model when a parameter of a node of the graph model satisfies a predefined condition.

### BACKGROUND

### Technical Field

The present disclosure relates to a computer-implemented method for simulating the evolution of a reservoir due to dissolution induced by a flow of fluid, for instance water, in the reservoir.

### Description of the Related Art

Dissolution is a phenomenon by which a fluid, for instance water, infiltrated in a reservoir, for instance of limestone, but also of dolomite, salt, ice or gypsum, causes a change in the porosity of the material constituting the reservoir, without inducing mineralogic change. Dissolution can result in formation of various types of voids, as conduits or cavities, within the reservoir.

In the study of reservoir, in order especially to have a good knowledge of the geometry of the reservoir, it is known to dynamically reproduce the geological and hydrological processes occurring within the reservoir, including dissolution processes, which are part of diagenetic processes.

For instance, WO2012/045936 discloses a method for simulating karstification phenomena, corresponding to dissolution of carbonated rock by water, comprising steps of:
defining a gridded geological model of a karstic reservoir, the model describing two media where a first medium, is described by values of a geological grid parameter, and a second medium is described by parameters of edges between two nodes of a cell;
simulating stochastic displacements of particles in the grid of the geological model, the probability of each displacement of a particle being calculated by taking into account the medium in which the displacement is carried out; and
modifying the values describing the first and second media according to the courses taken by the particles.

This document enables modelling the path of the particles in a geological model describing two media. This document further discloses computing for each particle an advective displacement and a dispersive displacement repeatedly for a plurality of cycles. It also enables updating parameters of the model representing the reservoir, up to a limit which may not correspond to any geometrical reality.

However, this document does not enable explicitly rendering the evolution of the geometry of the reservoir as a consequence of dissolution, and in particular modifying the topology of the model in order to respect the geometry of the reservoir.

### BRIEF SUMMARY

The present disclosure aims at improving the prior art.

In particular, an aim of the present disclosure is to improve the quality of the simulation.

An aim of the present disclosure is to make it possible to simulate explicitly the evolution of the geometry of a reservoir including conduits and surface discontinuities, as a consequence of dissolution within the reservoir,

To this end, disclosed herein is a computer-implemented method for simulating the evolution of a reservoir due to dissolution within the reservoir, comprising:
representing the reservoir by a graph model comprising a plurality of nodes and connections between the nodes, wherein each node is associated with at least one geological parameter;
simulating dissolution induced by a fluid flowing through the reservoir during a determined time period, wherein said simulation comprises computing updated values of geological parameters assigned to the nodes of the graph model as a consequence of said dissolution; and
updating the topology of the graph model when a parameter of a node of the graph model satisfies a predefined condition.

In embodiments, updating the topology of the graph model comprises suppressing a node when a parameter of the node satisfies a predefined condition.

In embodiments, updating the topology of the graph model further comprises generating new connections between the nodes that were previously connected to the suppressed node.

In embodiments, each node is associated with at least a volume of void parameter, and updating the topology of the graph model comprises distributing the volume of void of the suppressed node to the nodes to which the suppressed node was connected.

In embodiments, simulating dissolution induced by a fluid flowing through the reservoir comprises:
computing a flow field within the graph model;
for each of plurality of particles representing a volume of fluid flowing through the reservoir, each particle being associated with a volume of rock that the particle is able to dissolve, computing a path of the particle within the graph model based on the computed flow field, the path comprising a plurality of adjacent nodes of the graph;
determining a volume of rock dissolved by the particle at each node of the path of the particle; and
updating the parameters of the nodes according to the dissolved volume of rock.

In embodiments, the method further comprises, after updating the topology of the reservoir, iterating the steps of simulating dissolution and updating the topology of the reservoir.

In embodiments, the graph model represents at least two geological media, comprising a first medium corresponding to a porous matrix, and at least another medium corresponding to surface discontinuities or conduits within the porous matrix, wherein each node of the graph model corresponds to a selected one among the at least two media, and the connections between the nodes include connections between two nodes corresponding to the same medium and connections between nodes corresponding to any two different media.

In embodiments, the graph model represents at least two geological media comprising a porous matrix, and surface discontinuities within the porous matrix, and updating the topology of the graph model further comprises, when the suppressed node corresponds to the porous matrix, and said node is connected to a node corresponding to a surface discontinuity, also suppressing the node corresponding to the surface discontinuity to which it is connected.

In embodiments, the nodes are associated with volume parameters, simulating dissolution comprises increasing the volume of at least one node corresponding to conduits or surface discontinuities, and reducing the volume of porous matrix of at least one node corresponding to the porous matrix, and wherein updating the topology of the graph model comprises suppressing a node corresponding to the porous matrix when its volume decreases below a determined threshold.

In embodiments, the determined threshold is a percentage of the initial volume associated with the node or a minimum volume.

In embodiments, the nodes are associated with parameters including at least a volume of void parameter, simulating dissolution comprises updating the volume of void parameter of some nodes as a consequence of dissolution, and the topology of the graph model is updated when the volume of void parameter of a node satisfies a predefined condition.

In embodiments, the volume of void parameter associated with nodes corresponding to conduits or surface discontinuities comprises a transverse dimension of the conduits or the surface discontinuities, and updating the topology of the graph model comprises suppressing a node corresponding to a conduit when said node is connected to a node corresponding to a surface discontinuity and the updated transverse dimension of the surface discontinuity is greater than the updated transverse dimension of the conduit.

In embodiments, the volume of void parameter associated with nodes corresponding to the porous matrix includes a porosity, and updating the topology of the graph model comprises suppressing the node corresponding to the porous matrix if its porosity exceeds a predetermined porosity threshold.

In embodiments, the method comprises applying a first porosity threshold when the node corresponding to the porous matrix is connected to a node corresponding to a conduit, and a second porosity threshold when the node corresponding to the porous matrix is not connecting to a node corresponding to a conduit, the first porosity threshold being lower than the second porosity threshold.

In embodiments, the graph model represents a medium corresponding to conduits within the porous matrix, and updating the topology of the graph model further comprises activating new conduits within the graph model.

In embodiments, the graph model represents three geological media comprising a porous matrix, surface discontinuities within the porous matrix and conduits within the porous matric, and representing the reservoir by a graph model comprises generating the graph model from a three-dimensional meshed model representing the reservoir, the three-dimensional meshed model comprising a plurality of three-dimensional polyhedrons conforming to the surface discontinuities and conduits of the reservoir, wherein a surface discontinuity is represented by a two-dimensional (2D) meshed surface where each cell of the surface is a face of a three-dimensional (3D) polyhedron, and each conduit is represented by a one-dimensional (1D) meshed line where each cell of the line is an edge of a 3D polyhedron,
the generation of the graph model comprising:
   generating nodes corresponding to the porous matrix at the center of each polyhedron;
   generating nodes corresponding to the surface discontinuities at the center of each face of a polyhedron forming a 2D meshed surface representing a surface discontinuity;
   generating nodes corresponding to the conduits at the center of each edge of a polyhedron corresponding to a conduit; and
   generating connections between two adjacent nodes.

In embodiments, the generation of the graph model further comprises generating additional nodes at the center of each edge of a polyhedron that does not belong to a conduit, said additional nodes being initially inactive, with a null volume of void, and activating new conduits within the graph model comprises updating the permeability of additional nodes to a non-null value.

In embodiments, updating the permeability of the node to a non-null value comprises distributing some volume of void of suppressed nodes corresponding to the porous matrix to the nodes corresponding to inactive conduits adjacent to the suppressed nodes.

According to another aspect, disclosed herein is a computer-program comprising code instructions for implementing a method according to the description above, when it is executed by a computer.

According to another aspect, disclosed herein is a computing device comprising at least a memory and a circuit configured to implement a method according to the description above.

According to another aspect, disclosed herein is a non-transitory computer-readable storage medium having stored thereon instructions which, when executed by at least one processor, cause the processor to carry out a method according to the description above.

The proposed method enables updating the topology of the graph model representing the reservoir in order to conform to the geometry of the reservoir. Specifically, the network of conduits and surface discontinuities may evolve within the reservoir model, at the expense of the porous matrix.

### BRIEF DESCRIPTION OF THE SEVERAL VIEWS OF THE DRAWINGS

Other features and advantages of the present disclosure will be apparent from the following detailed description given by way of non-limiting example, with reference to the accompanying drawings, in which:

FIG. 1 schematically represents the main steps of a method according to an embodiment.

FIG. 2a represents an exemplary graph model that may be used in the method according to an embodiment, and FIG. 2b represents a three-dimensional mesh from which the graph model is obtained.

FIGS. 3a to 3f represent conventions of notations for computing transmissibility between nodes of the graph model.

FIGS. 4a and 4b schematically represent the evolution of fluid flow within the model with dissolution.

FIG. 5 schematically represents a device for implementing the method.

FIG. 6 represents an example of a polyhedron and the nodes corresponding to different media that have been generated from the polyhedron.

FIG. 7 represents an example of the evolution of a potential of dissolution of a particle with the distance travelled by the particle.

FIG. 8a represents another example of graph topology update in which a node corresponding to porous matrix connected to a conduit is suppressed.

FIG. 8b represents another example of graph topology update in which a node corresponding to porous matrix not connected to a conduit is suppressed, and new conduits are activated.

FIG. 8c represents another example of graph topology update in which a node corresponding to porous matrix connected to both a conduit and a surface discontinuity is suppressed.

### DETAILED DESCRIPTION

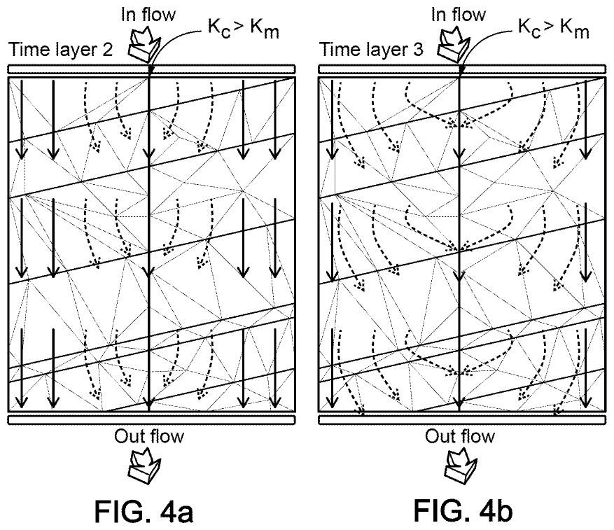

Embodiments of a computer-implemented method for simulating the evolution of a reservoir will now be disclosed. With reference to FIG. 5, the method may be implemented by a device 10 comprising a computer, this computer comprising a memory 15 to store program instructions loadable into a circuit and adapted to cause circuit 14 to carry out the steps of the method when the program instructions are run by the circuit 14.

The memory 15 may also store data and useful information for carrying the steps of the method.

The circuit 14 may be for instance:
a processor or a processing unit adapted to interpret instructions in a computer language, the processor or the processing unit may comprise, may be associated with or be attached to a memory comprising the instructions; or
the association of a processor/processing unit and a memory, the processor or the processing unit adapted to interpret instructions in a computer language, the memory comprising said instructions; or
an electronic card wherein the steps of the present disclosure are described within silicon; or
a programmable electronic chip such as a FPGA chip (for «Field-Programmable Gate Array»).

This computer comprises an input interface 13 for the reception of several data used for the method, for instance the graph model or a three-dimensional meshed model from which the graph model may be obtained, some parameters of the topography of the modelled reservoir, parameters regarding the boundary conditions of the fluid flow through the reservoir, etc. This computer also comprises an output interface 16 for outputting updated data regarding the reservoir.

To ease the interaction with the computer, a screen 11 and a keyboard 12 or a tactile screen may be provided and connected to the computer circuit 14. The various components described above may be remotely connected to one another, i.e., the memory storing the data and/or the circuit implementing the method may be remotely located with reference to the user and accessible through any suitable network.

The reservoir in which dissolution is simulated may be a carbonated reservoir, possibly including karstic features, but may also be a reservoir of salt, of gypse, of ice, or any other material in which dissolution can occur.

The method for simulating evolution of the reservoir due to dissolution may be implemented for simulating the evolution of a reservoir that may be observed in a real site, and from which input parameters describing the geometry of the reservoir, the nature of rock, etc., may be acquired in order to perform simulation. The method enables predicting the location and the development of underground network cavities, for instance karstic networks.

The method may for instance be implemented in order to simulate the evolution of a reservoir from a previous state until a later state, for instance from a past state until a current state observable in reality, or from a current state observable in reality until a future state. Thus, the method may allow better understanding the geometry of the current state of a reservoir, and predicting circulation of fluid flows or locate underground cavities. According to an example, the method may for instance be implemented for predicting circulation of pollutants in a karstic reservoir, in order to prevent or anticipate groundwater contamination. According to another example, the method may be implemented in order to ensure that a construction may be built at a defined location, while avoiding any risk of collapse due to underground cavities. According to still another example, the method may be implemented in order to better understand the configuration of a karstic reservoir and allow enhanced oil or gas recovery or monitor carbon dioxide injection for underground storage. Thus, the method may be implemented with a view to at least one of the following applications: groundwater resources management, hydrocarbon recovery, carbon dioxide storage, civil engineering, urbanism, and/or agriculture.

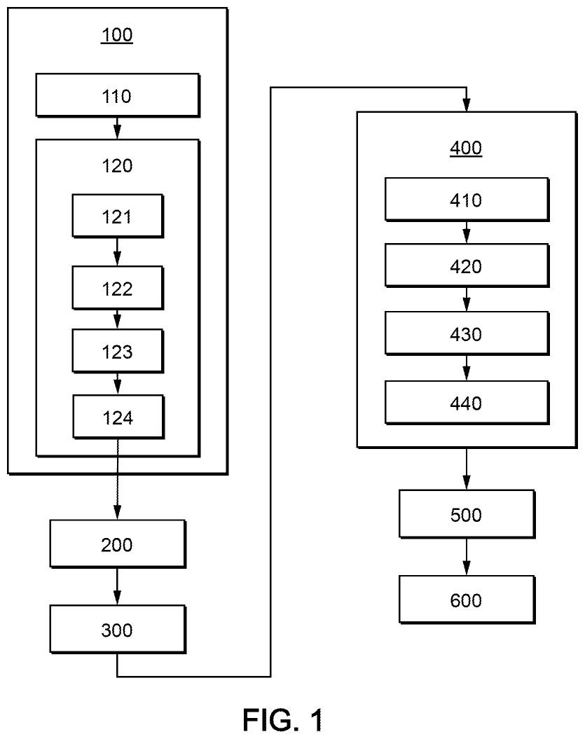

With reference to FIG. 1, the main steps of a method for simulating the evolution of a reservoir caused by dissolution within the reservoir will now be described.

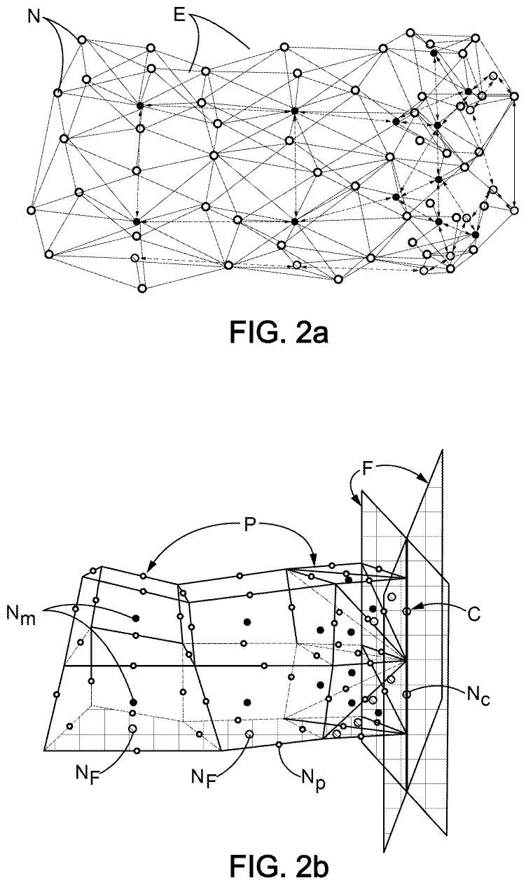

The method comprises a step 100 of receiving a graph model of the reservoir, comprising, as shown for instance in FIG. 2a, a plurality of nodes N and connections E between the nodes. Each node represents a geological element of the reservoir and is associated with at least one geological parameter which defines local properties of the reservoir. The at least one geological parameter may include parameters describing the geometry of the geological element represented by the node, for instance, but not exclusively, a volume of said element. The at least one geological parameter may include a parameter describing a volume of void of the geological element represented by the node. By “volume of void”, it is meant a volume, within the element, that is not filled with rock and may instead be filled by a fluid and enable the flowing of a fluid. The at least one geological parameter may include permeability. The at least one parameter may further include one or more parameters defining the sensibility of the geological element corresponding to the node to dissolution.

In particular, each node may be associated with a set of geological parameters comprising all or part of the examples given above.

Each node may also be associated with three-dimensional coordinates in a three-dimensional space associated with the reservoir.

The connections between the nodes may also be associated with parameters, for instance to transmissibility parameters from one node to an adjacent node.

In embodiments, the graph model of the reservoir represents a plurality of media, and each node belongs to a single one among the plurality of media.

For instance, the graph model may represent a first medium corresponding to the porous matrix of rock, or any other material (salt, ice, etc.) constituting the reservoir, the term “porous matrix” not being limited, in what is described below, to a reservoir of rock, but can also designate a matrix of salt, ice, or any other relevant porous material.

The graph model may also represent at least a second medium corresponding to discrete features within the matrix, for instance conduits or surface discontinuities, such as faults, fractures, or horizons.

In embodiments, the graph model may represent three media, comprising a first medium corresponding to the porous matrix, a second medium corresponding to surface discontinuities, for instance faults or horizons, and a third medium corresponding to karst conduits.

In this case, the parameters describing the geometry of the geological element represented by a node may comprise:
for the nodes representing a surface discontinuity, an area of the part of the surface discontinuity represented by the node and an aperture of the surface discontinuity, i.e., a dimension in a direction transverse to the plane of the surface discontinuity. The parameters may also comprise the volume of the surface discontinuity, which can be obtained from the area and aperture of the surface discontinuity; and
for the nodes representing a conduit, a length of the part of the conduit represented by the node, and a diameter or radius of the conduit. The parameters may also comprise the volume of the conduit, which can be obtained from the length and diameter or radium of the conduit.

The volume associated with nodes representing a conduit or a surface discontinuity also corresponds to a volume of void since conduits and surface discontinuities are hollow areas within the reservoir.

Furthermore, the parameters associated with a node representing the porous matrix may comprise:
a volume of the element represented by the node;
a porosity of the porous matrix;
a volume of void of the matrix; or
a volume of the solid matrix, i.e., the volume of material constituting the matrix, excluding the volume of void.

In embodiments, the graph model of the reservoir may be recovered during step 100 from a storage device where it has been preliminary stored. The storage device can be a memory or a remote server.

In other embodiments, the step 100 of receiving the graph model of the reservoir comprises a step 110 of receiving a three-dimensional meshed model representing the reservoir, and 120 generating, from said three-dimensional meshed model, a graph model.

With reference to FIG. 2b, the three-dimensional meshed model comprises a plurality of three-dimensional polyhedrons P, each polyhedron being defined by a plurality of vertices, i.e., of three-dimensional points associated with three-dimensional coordinates. Each polyhedron is also defined by a plurality of two-dimensional planar faces, where each face is defined by at least three vertices, and a plurality of one-dimensional edges forming the sides of a face, each edge being a connection between two vertices. According to a non-limiting example, the polyhedrons may be tetrahedrons or hexahedrons. The three-dimensional polyhedrons may further be associated with petrophysical parameters, including for instance values of permeability, porosity, a type of material or facies, a type of facies environment, etc.

Furthermore, the three-dimensional meshed model may include surface discontinuities F and/or conduits C within the reservoir. In that case, the three-dimensional meshed model conforms to said surface discontinuities and/or said conduits, i.e., surface discontinuities are represented in the three-dimensional meshed model, by two-dimensional meshed surfaces where each cell of the surfaces is a face of a 3D polyhedron, and conduits are defined by one dimensional meshed lines which cells are formed by one or more consecutive edges of polyhedra.

The generation 120 of the graph model from this three-dimensional meshed model may comprise generating nodes 121 and generating connections 122 between the adjacent nodes. As described in more details below, connections between the nodes are generated for any two adjacent nodes, whatever the medium to which belong the adjacent nodes, and even if the adjacent nodes correspond to two different media. Hence, the graph is a complete graph. Further, nodes are associated with parameters 123 which may be derived from the meshed model, and transmissibility values are associated 124 to the connections between the adjacent nodes.

More specifically, the conversion 120 of the meshed model into a graph may comprise generating 121 nodes Nₘ corresponding to the porous matrix at the center of each polyhedron.

If the three-dimensional meshed model includes at least one surface discontinuity, the conversion into the graph model may further comprise generating at step 121 nodes Nₛ corresponding to the surface discontinuities, said nodes being located at the center of each cell of a surface discontinuity, i.e., at the center of each face of a polyhedron conforming to the surface discontinuity.

In some embodiments, when the three-dimensional meshed model includes at least a conduit, the conversion 120 may further comprise generating at step 121 nodes N_{c} corresponding to the conduits C at the center of each edge of a polyhedron corresponding to a conduit.

Connections are then generated at step 122 between all pairs of adjacent nodes, whatever the media to which belong the nodes, and even between the additional nodes and the other nodes.

The generation of the graph model then comprises associating at step 123 information to each node. This comprises computing and associating three-dimensional coordinates to each node, the coordinates being computed from the coordinates of the vertices of the meshed model.

It also comprises associating at least one parameter with each node. As indicated above, the at least one parameter may include geometrical parameters, which are inferred from the geometry of the initial meshed model, at least a value of volume of the geological element represented by the node, and a permeability value.

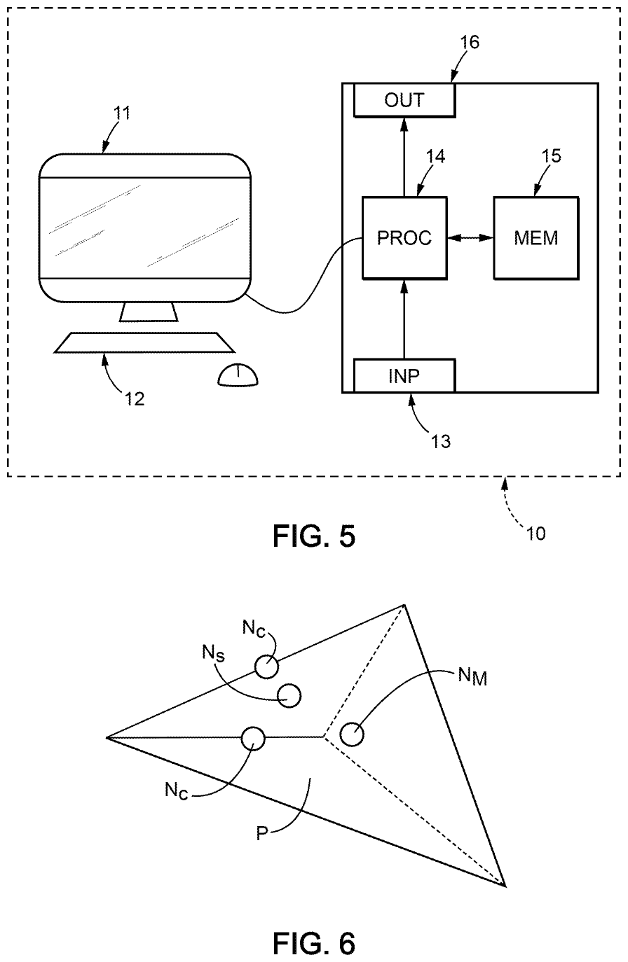

Regarding the nodes Nₛ corresponding to surface discontinuities, the geometrical parameters assigned to the nodes comprise an aperture b_{F}_{ⱼ} of the surface discontinuity, and an area A_{F}_{ⱼ} associated with the node, where j is the index of the node. The area associated with the node corresponds to the area of the face of the polyhedron from which the node has been generated, or, when a conduit is located on an edge of said face, as for instance in FIG. 6, it corresponds to the area A_{P}_{ⱼ} of the face of the polyhedron minus the area represented by the conduit k of diameter D_{C}_{ₖ} and length L_{C}_{ₖ};

$${A}_{{F}_{j}} = {A}_{{P}_{j}} - ( \frac{{D}_{{C}_{k}}}{2} {L}_{{C}_{k}} )$$

The volume of the surface discontinuity may then be computed as the product of the area and aperture: V_{F}_{ⱼ}=b_{F}_{ⱼ}·A_{F}_{ⱼ}. This volume corresponds to a volume of void.

The permeability of a node corresponding to a surface discontinuity may be computed from aperture as follows:

$${K}_{{F}_{j}} = \frac{{{b}_{{F}_{j}}}^{2} ρ g}{12 μ} = \frac{{{b}_{{F}_{j}}}^{2} g}{12 v}$$

where μ is the dynamic viscosity and v is the kinematic viscosity of the considered fluid.

Regarding the nodes N_{C} corresponding to conduits, the geometrical parameters assigned to the nodes comprise a length L_{C}_{ₖ} of the conduit, which is the length of the edge of the polyhedron from which the node has been generated, and a diameter D_{C}_{ₖ} or radius. The diameter or radius of the conduit may be derived from the diameter of the radius of the conduit represented in the meshed model.

The volume of the conduit may then be computed as:

$${V}_{{C}_{k}} = {π ( \frac{{D}_{{C}_{k}}}{2} )}^{2} {L}_{{C}_{k}}$$

The permeability of a node corresponding to a conduit may be computed as follows:

$$log ( {K}_{{C}_{k}} ) = \frac{1}{3} log ( {Kl}_{{C}_{k}} ) + \frac{2}{3} log ( {Kt}_{{C}_{k}} )$$

$${Kl}_{{C}_{k}} = \frac{g \cdot {{D}_{{C}_{k}}}^{2}}{32 v ( 1 + 8.8 {kr}^{3 / 2} )}$$

$${Kt}_{{C}_{k}} = 2 log ( \frac{1.9}{kr} ) \sqrt{2 g \cdot {D}_{{C}_{k}}}$$

where kᵣ is the relative rugosity of the material forming the porous matrix.

Regarding the nodes N_{M} belonging to the porous matrix, the associated parameters may include the volume of the polyhedron from which the node has been generated.

This volume V_{P}_{ᵢ} comprises a volume of rock and a volume of void (also being parameters associated with the node): V_{P}_{ᵢ}=V_{V}_{ᵢ}+V_{R}_{ᵢ}.

The volume of void V_{V}_{ᵢ} includes:
the volume of void resulting from porosity within the porous matrix;
optionally the volume of a part the one or more surface discontinuities at corresponding faces of the polyhedron, i.e., half the volume of each surface discontinuity located at a corresponding face of the polyhedron, since one surface extends between two polyhedral; and
optionally the volume of a part of the one or more conduits at corresponding edges of the polyhedrons, i.e., the volume of the part of each conduit contained by the polyhedron:

$${V}_{{V}_{i}} = {V}_{{M}_{i}} \cdot {∅}_{i} + {\sum }_{j = 1}^{jFi} {V}_{{F}_{j , i}} + {\sum }_{k = 1}^{kCi} {V}_{{C}_{k , i}}$$

where V_{M}_{ᵢ} is the volume of the porous matrix of the polyhedron i, V_{F}_{_{j,i}} is the part of the volume of a surface discontinuity j on a surface of the polyhedron i and V_{C}_{_{k,i}} is the part of the volume of a conduit k on an edge of the polyhedron i belonging to this polyhedron.

The volume of rock V_{R}_{ᵢ} is the volume of the solid matrix from which is deduced the volume of void resulting from porosity Øᵢ V_{R}_{ᵢ}=V_{M}_{ᵢ}·(1−Øᵢ)

The permeability value of the node may also be equal to the permeability associated with the polyhedron from which the node has been generated, if this parameter is defined. Alternatively, an initial porosity may be associated with a polyhedron or to the node generated from the polyhedron, and an initial permeability of the node may be derived from the porosity, for instance by application of a formula of the type:

$$log ( {K}_{i} ) = A {∅}_{i} + B$$

where Kᵢ is the permeability of the node and A and B are constants that depend upon the material forming the porous matrix.

In embodiments, the conversion of the three-dimensional meshed model into a graph may further comprise generating a node Np at the center of each edge of a polyhedron of the meshed model which neither corresponds to a conduit nor to a surface discontinuity, the nodes Np being associated with an initially null radius and hence a null permeability value. As described in more details below, the generation of these nodes with initial null permeability value enables simulating apparition of new conduits within the reservoir as a result of dissolution.

Once permeability values are associated with the nodes of the graphs, the method further comprises a step 124 of computing transmissibility values associated with the connections between the nodes. The transmissibility values may be computed from the permeability values associated with the two nodes that are linked by a connection.

In embodiments in which the graph model is converted from a three-dimensional meshed model, the transmissibility value of a connection may be computed from the permeability values associated with the connection and the geometry of the elements of the 3D meshed model from which the nodes have been derived.

According to a general description, the transmissibility may be computed according to a Two Points Flux Approximation, wherein if two nodes connected by a connection are denoted 1 and 2, then the transmissibility of the connection may be computed as follows:

$${T}_{1 , 2} = \frac{{T}_{1} \cdot {T}_{2}}{{T}_{1} + {T}_{2}}$$

Where T1, resp. T2, denotes the transmissibility between the node 1, resp. 2 and a surface at the interface between the two objects to which correspond the nodes, also denoted as contact surface. Tᵢ, where i equals 1 or 2, can be defined as follows:

$${T}_{i} = \frac{{K}_{i} \cdot {\vec{d}}_{l} \cdot {\vec{n}}_{l} \cdot {A}_{i , j}}{{‖ {\vec{d}}_{l} ‖}^{2}}$$

Where d̅ᵢ̅ is the vector between node I and the center of the contact surface between the nodes 1 and 2, n̅ᵢ̅ is the normal to the contact surface; A_{i,j} is the area of the contact surface of the element represented by node I with the element represented by node j, as seen from the node i, and Kᵢ is the permeability of the node i.

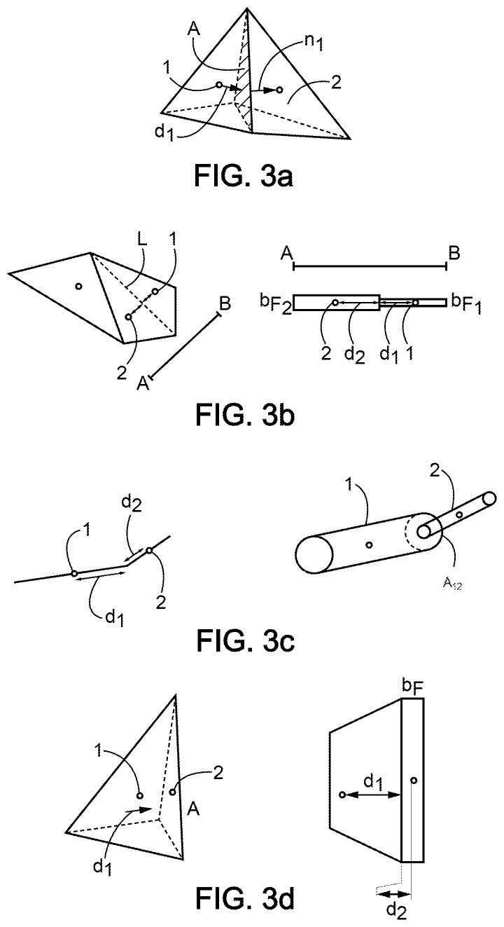

With reference to FIG. 3a, for the calculation of transmissibility between two nodes corresponding to a porous matrix, the contact surface is defined as the face in common between the two polyhedrons from which the nodes have been generated. The transmissibility Tᵢ for each zone may thus be readily computed from the equation above.

With reference to FIG. 3b, for the calculation of transmissibility between two nodes corresponding to a surface discontinuity, these nodes have been generated at the center of faces of polyhedrons. The faces from which the nodes have been generated share a common edge since the nodes are adjacent Let L_{i,j} be the length of the common edge at the intersection of the considered faces, the area A_{i,j} of the contact surface between the nodes, considered from node i, is equal to

$${A}_{i , j} = {b}_{{F}_{i}} {L}_{i , j}$$

where b_{F}_{ᵢ} is the aperture of node i. The vector d̅ᵢ̅ in that case is the vector between the node and the center of the segment, and the vector n̅ᵢ̅ is the normal to the segment that is included within the plane of the face from which the node has been generated. The same applies mutatis mutandis for the computation of the area A_{j,i} of the contact surface between the nodes, considered from node j.

With reference to FIG. 3c, for the calculation of transmissibility between two nodes corresponding to a conduit, these nodes have been generated at the center of an edge of a polyhedron. d̅ᵢ̅, n̅ᵢ̅ is half of the length of the edge from which the node has been generated. Considered from node i.

$${A}_{i , j} = π {{r}_{i}}^{2}$$

where rᵢ is the radius of the conduit corresponding to node i. The same applies mutatis mutandis for the computation of the area A_{j,i} of the contact surface between the nodes, considered from node j.

With reference to FIG. 3d, for the calculation of transmissibility between a node corresponding to a surface discontinuity and a node corresponding to the porous matrix, the contact surface corresponds to the face of the polyhedron that conforms to the surface discontinuities and at the center of which the node corresponding to the porous matrix has been generated. Its area is derived from the meshed model. The distance between the node corresponding to the surface discontinuity and the surface is equal to b_{F}/2 where b_{F} is the aperture of the surface discontinuity.

With reference to FIG. 3e, for the calculation of transmissibility between a node corresponding to a conduit and a node corresponding to the porous matrix, the conduit corresponds to an edge of the polyhedron from which the node corresponding to the porous matrix has been generated and hence the contact surface is defined by the curvilinear section of the conduit that is inside the polyhedron. This surface A_{c} may be computed from the radius of the conduit and the angle θ (rad) formed by the faces of the polyhedron intersecting at the edge corresponding to the conduit, according to the following equation:

$${A}_{c} = r θ L$$

where L is the length of the edge. dᵢ, on the side of the node corresponding to the conduit, is equal to the radius of the conduit, and dj on the side of the node corresponding to the porous matrix, is equal to the distance between the node and the edge, minus the radius of the conduit.

With reference to FIG. 3f, for the calculation of transmissibility between a node corresponding to a conduit and a node corresponding to a surface discontinuity, the node corresponding to the conduit is located at an edge of the surface corresponding to the surface discontinuity.

Thus, if i denotes the node corresponding to the conduit and j denotes the node corresponding to the surface discontinuity:

A_{i,j}=A_{j,i}=π·rᵢ·L, if rᵢ<b_{F}_{ⱼ}, which is the example represented in the upper, right-hand side of FIG. 3f; and

$${A}_{i , j} = {A}_{j , i} = {b}_{{F}_{j}} \cdot L , if {r}_{i} \geq {b}_{{F}_{j}} ,$$

where L is the length of the edge at the center of which is the node corresponding to the conduit, b_{F}_{ⱼ} is the aperture of the surface discontinuity and rᵢ is the radius of the conduit.

dᵢ on the side of the conduit is equal to the radius of the conduit and, dⱼ on the side of the surface discontinuity, is equal to the distance between the node and the edge corresponding to the conduit, minus the radius of the conduit.

Last, the transmissibility of a connection between an additional node with an initially null permeability value and another node is zero.

Once the graph model is obtained, the method comprises at least one iteration of simulating dissolution within the reservoir during a determined period of time, where the flow of fluid imparting dissolution is represented by a plurality of particles flowing through the graph model.

The determined period of time corresponds to a geological period of time that is simulated during one iteration of the dissolution simulation. This period of time may be set by the user, and is preferably comprised between 1 and 100.000 years, for instance between 10 and 1000 years.

Prior to simulating dissolution, the method comprises a step 200 of defining flow boundary conditions of the graph model and a number of parameters for the simulation.

The flow boundary conditions may comprise input boundary conditions. The input boundary conditions can comprise one or more input locations for the fluid within the reservoir. According to an embodiment, the input location for the fluid may be formed by a or several entrance surface(s) called a recharge area, formed by a plurality of nodes defined by the user.

For instance, the recharge area may be a top surface, i.e., located at the roof of the reservoir, considering the axis top-bottom as the axis of the gravity.

The input boundary conditions may also comprise an amount of fluid entering the reservoir during the time period, which may be expressed explicitly, or controlled by a hydraulic head or a fluid flow. In what follows, let Re be the volume of fluid that enters the graph during the time period, in m³.

The flow boundary conditions may also comprise output boundary conditions, which can comprise one or more output locations for the fluid, and an amount of fluid exiting the reservoir, which can be expressed explicitly, or controlled via a hydraulic head at the output location.

A number of particles nₚ, each particle representing the amount of fluid entering the reservoir during the determined period of time, may also be defined by the user. This number of particles has to be superior or equal to the number of nodes by which the fluid enters the graph (number of nodes of the recharge area), and may for instance be a multiple of this number.

Step 200 also comprises determining a number of particles entering the graph at each input node, and assigning each particle a volume of rock that the particle is able to dissolve over its whole path within the model. This volume of rock is representative of the period of time that is simulated.

In embodiments, the user may set a value of specific dissolution SD of the whole reservoir, corresponding to the volume of rock that is dissolved over the whole reservoir during a defined period of time.

The volume of rock dissolved over the whole reservoir is related to the recharge R_{c}, i.e., the volume of fluid entering the graph during the time period, by:

$${SD}_{v} = α * {R}_{e}$$

where alpha is a coefficient representative of the aggressivity of the fluid, i.e., its capacity to dissolve the material forming the reservoir. Thus, alternatively a coefficient alpha may be set by the user and the specific dissolution SDᵥ may be derived from alpha and R_{c}. The volume of rock that a particle is able to dissolve during its path within the reservoir is thus equal to SDₚ=SDᵥ/nₚ.

The number of particles entering the graph at each input node is the ratio between the total number of particles nₚ and the number of input nodes defined by the user.

A steady state flow field within the graph model may then be computed during a step 300, from the boundary conditions and by application of the diffusivity equation, resulting from coupling of the Darcy's law describing the flow of a fluid through a porous medium and the law of mass conservation. As the reservoir model is a complete graph, i.e., a graph where each node is connected to all adjacent nodes, where the three media are all represented by nodes, and the connections between two nodes, whatever the medium to which they belong, are associated with a parameter of transmissibility, the computation of the flow field can be performed using a finite volume resolution method known to the skilled person.

Simulating dissolution 400 induced by fluid flow represented by the particles then comprises, for at least one particle, and preferably for all the particles np that are introduced in the graph during the time period, determining 410 the path of the particle through the graph model. As the simulation is performed for a determined period of time, covering occurrence of geological events, the whole path of the particle is determined, from the input node of the particle to an output node, or to a node corresponding to a final location of the particle within the graph.

The path of the particle comprises a sequence of adjacent nodes beginning by the input node and ending by the output node.

The determination 410 of the path of the particle comprises determining, from a current node a probability of displacement of the particle from the current node to each adjacent node, wherein the probability of displacement between the current node and an adjacent node is computed according to the transmissibility of the connection between the current node and the adjacent node, and the difference between the hydraulic heads of the two nodes, the hydraulic heads being a result of the flow field.

The probability of a particle going from a node i to a node j₀ may be computed as follows, when hᵢ−hⱼ_{₀}>0:

$${P}_{i , {j}_{0}} = \frac{( {h}_{i} - {h}_{{j}_{0}} ) \cdot {T}_{i , {j}_{0}}}{{\sum }_{j = 1}^{{n}_{connection}} ( {h}_{i} - {h}_{j} ) \cdot {T}_{i , j}}$$

With n_{connection} the number of connections associated with node i, for which hᵢ−hⱼ>0, T_{i,j} the transmissibility associated with the connection between i and j and hᵢ the hydraulic head associated with a node i. When hᵢ−hⱼ≤0, then P_{i,j}=0.

The path of the particle may then be determined from the probabilities assigned to each connection, by running a cellular automaton, for instance a lattice gas automaton.

Once the sequence of nodes forming the path of the particle is determined, the simulation of dissolution comprises determining 420 a volume of rock dissolved by the particle at each node belonging to the path of the particle, from the total volume of rock dissolved by the particle within the reservoir.

As the graph model represents a plurality of media, the determination of the volume of rock dissolved by the particle at each node is performed according to the medium to which corresponds the node.

The volume of rock dissolved by the particle along its path is the sum of the volume of rock dissolved in all the media of the model, for instance:

$$SDp = {v}_{M} + {v}_{F} + {v}_{C}$$

where v_{M} is the volume of rock dissolved by the particle in nodes of the porous matrix, v_{F} is the volume of rock dissolved by the particle in nodes corresponding to surface discontinuities and v_{C} is the volume of rock dissolved by the particle in nodes corresponding to conduits.

The volume of rock UM dissolved by the particle in nodes of the porous matrix can be computed as:

$${v}_{M} = {SD}_{p} \cdot \frac{{\sum }_{i = 1}^{imax} {V}_{{M}_{i}} \cdot {β}_{i} \cdot {DP}_{i}}{\begin{matrix}{\sum }_{i = 1}^{imax} {V}_{{M}_{i}} \cdot {β}_{i} \cdot {DP}_{i} + {\sum }_{j = 1}^{jmax} {V}_{{F}_{j}} \cdot {β}_{j} \cdot \\ {DP}_{j} + {\sum }_{k = 1}^{kmax} {V}_{{C}_{k}} \cdot {β}_{k} \cdot {DP}_{k}\end{matrix}}$$

where:
   i is the index corresponding to nodes belonging to the matrix;
   imax the number of matrix nodes along the path of the particle;
   V_{M}_{ᵢ} is the volume of the porous matrix at node i;
   j is the index corresponding to nodes belonging to surface discontinuities;
   jmax the number of discontinuities nodes along the path of the particle;
   V_{F,j}, is the volume of the surface discontinuity at node j;
   k is the index corresponding to the nodes belonging to the conduits;
   V_{C,k} is the volume of a conduit at node k;
   β_{i,j,k} is a parameter describing the sensibility of rock to dissolution; and
   DPᵢ is a potential of dissolution of the particle at the node i.

In embodiments, the potential of dissolution DP of the particle evolves along the path of the particle, i.e., it depends on the considered node. Hence, the volume of rock dissolved by the particle at a node depends on the position of the node within the path.

Indeed, the infiltration of water through the first layers of the ground can increase its concentration of water in CO2, thereby rendering the water more acid at the beginning of the path, which corresponds to a high dissolution potential. The progressive dissolution of rock by water then causes a reduction of the concentration of CO2 and a progressive diminution of acidity and of the dissolution potential.

Thus, DPi may be a factor comprised between 0 and 1 and decreasing with the position of node i within the path of the particle, or said otherwise, with the distance of node i from the input node of the path, or with the time spend by the particle in the reservoir.

According to an example, the decrease of the dissolution potential may be a linear decrease expressed as:

$${DP}_{i} = ( {DP}_{min} - {DP}_{max} ) \cdot {L}_{i} + {DP}_{max}$$

where DPₘₐₓ and DPₘᵢₙ are respectively maximum and minimum values of the factor DP, and may be set by the user. According to non-limiting examples, DPmax may be comprised between 0.5 and 1, for instance equal to 1, and DPmin may be comprised between 0 and 1, for instance equal to 0.2. Lᵢ represents the distance travelled by the particle between the beginning of the path and the node i. This distance is preferably normalized as a percentage of the whole path of the particle. According to an example, if the path of a particle comprises 20 nodes, the distance of node 15 may be equal to 15/20=0.75. According to another example, each connection between two nodes may be associated with a distance between the nodes, and Li may be sum of the length of the connections crossed by the particle until node I, normalized.

According to another example, the decrease of the dissolution potential may be exponential, for example expressed as:

$${DP}_{i} = {DP}_{min} + ( {DP}_{max} - {DP}_{min} ) * exp ( b * ( - {L}_{i} ) )$$

With the same notations as above and b being a strictly positive value that can be set by the user or predefined.

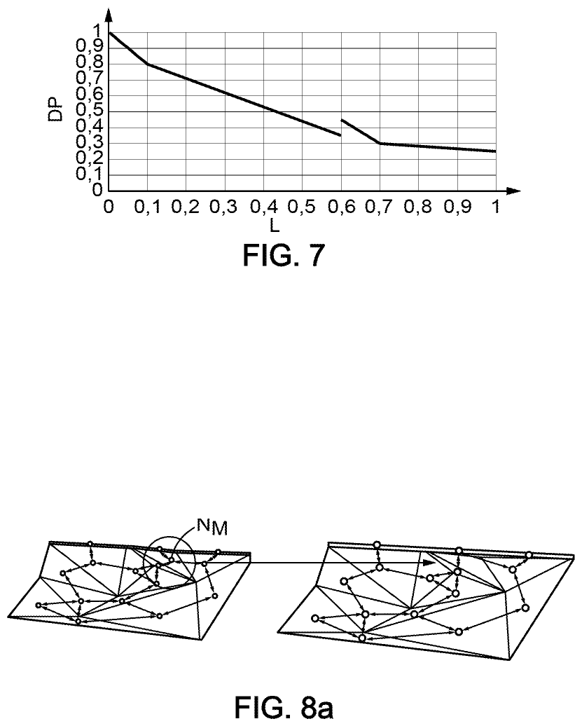

According to another embodiment, several zones may be defined within the reservoir and minimum and maximum values of the dissolution potential may be defined for each zone. An example is shown in FIG. 7, showing in abscisse the position of the considered node with respect to the normalized length of the path of the particle, and in ordinates the dissolution potential of the particle, where the dissolution potential is linear piecewise.

According to still another embodiment, the dissolution potential of the particle may decrease with the time spent by the particle within the reservoir. From the flow field, a speed of the particle or a time spent by the particle for crossing each connection may be derived, and hence, an average speed of the particle over the reservoir, or an average speed for each zone within the reservoir may be defined. The time spend by the particle may be computed as the ratio between the length travelled by the particle between the nodes and the average speed. This time may also be normalized.

The parameter β describing the sensibility of the rock to dissolution may depend on several aspects such as the facies of the rock, its mineralogic composition (proportion of minerals), etc. When the graph model has been obtained by conversion of a meshed model formed of polyhedrons, each polyhedron of the initial meshed model is associated with a facies and a mineralogic composition, or directly to a value of the parameter β, and said data is also associated with the nodes of the porous matrix that are generated at the center of the corresponding polyhedron.

For nodes corresponding to surface discontinuities, as these surface discontinuities extend at the interface between two polyhedrons, the parameter βⱼ associated with the surface discontinuity is the mean of the parameters Bi of said polyhedrons.

$${β}_{j} = \frac{1}{2} {\sum }_{i = 1}^{2} {β}_{i}$$

For nodes corresponding to conduits, a given conduit k extends at an edge which may be shared by a number iCk of polyhedrons, the parameter βₖ associated with the conduit k may also be the mean of the parameters βᵢ of the polyhedrons, weighted by the angle θᵢ formed by the polyhedron at the edge where the conduit is:

$${β}_{k} = \frac{1}{2 π} {\sum }_{i = 0}^{iCk} {β}_{i} {θ}_{i}$$

Similarly, the volume of rock v_{F} dissolved by the particle in the nodes of the path corresponding to surface discontinuities can be computed as:

$${v}_{F} = {SD}_{p} \cdot \frac{{\sum }_{j = 1}^{jmax} {V}_{{F}_{j}} \cdot {β}_{j} \cdot {DP}_{j}}{\begin{matrix}{\sum }_{i = 1}^{imax} {V}_{{M}_{i}} \cdot {β}_{i} \cdot {DP}_{i} + {\sum }_{j = 1}^{jmax} {V}_{{F}_{j}} \cdot {β}_{j} \cdot \\ {DP}_{j} + {\sum }_{k = 1}^{kmax} {V}_{{C}_{k}} \cdot {β}_{k} \cdot {DP}_{k}\end{matrix}}$$

The volume of rock v_{C} dissolved by the particle in nodes of the path corresponding to conduits can be computed as:

$${v}_{C} = {SD}_{p} \cdot \frac{{\sum }_{k}^{kmax} {V}_{{C}_{k}} \cdot {β}_{k} \cdot {DP}_{k}}{\begin{matrix}{\sum }_{i = 1}^{imax} {V}_{{M}_{i}} \cdot {β}_{i} \cdot {DP}_{i} + {\sum }_{j = 1}^{jmax} {V}_{{F}_{j}} \cdot {β}_{j} \cdot \\ {DP}_{j} + {\sum }_{k = 1}^{kmax} {V}_{{C}_{k}} \cdot {β}_{k} \cdot {DP}_{k}\end{matrix}}$$

Accordingly, for a given node of the path, the volume of rock dissolved by the particle can be computed as:

For a node i₀ corresponding to the porous matrix:

$${v}_{{M}_{{i}_{0}}} = {v}_{M} \cdot \frac{{V}_{{M}_{{i}_{0}}} \cdot {β}_{{i}_{0}} \cdot {DP}_{{i}_{0}}}{{\sum }_{i = 1}^{imax} {V}_{{M}_{i}} \cdot {β}_{i} \cdot {DP}_{i}}$$

For a node j₀ corresponding to a surface discontinuity:

$${v}_{{F}_{{j}_{0}}} = {v}_{F} \cdot \frac{{V}_{{F}_{{j}_{0}}} \cdot {β}_{{j}_{0}} \cdot {DP}_{{j}_{0}}}{{\sum }_{j = 1}^{jmax} {V}_{{F}_{j}} \cdot {β}_{j} \cdot {DP}_{j}}$$

For a node k₀ corresponding to a conduit:

$${v}_{{C}_{{k}_{0}}} = {v}_{C} * \frac{{V}_{{C}_{{k}_{0}}} \cdot {β}_{{k}_{0}} \cdot {DP}_{{k}_{0}}}{{\sum }_{k = 1}^{kmax} {V}_{{C}_{k}} \cdot {β}_{k} \cdot {DP}_{k}}$$

Once the volume of rock dissolved by the particle is computed for each node of the path, the method then comprises a step 430 of updating the at least one geological parameter assigned to the nodes of the path.

The dissolution process results in an augmentation of the volume of void of the reservoir, which corresponds to a diminution of the volume of rock since the sum of the volume of rock and the volume of void within the reservoir is constant. The augmentation of the volume of void can correspond to:
an augmentation of the porosity of the porous matrix;
an augmentation of the aperture of the surface discontinuities and thus of their volume, at the expense of the volume of adjacent porous matrix; and
an augmentation of the diameter of the conduits, and hence of their volume, at the expense of the volume of adjacent porous matrix.

Accordingly, the updated parameters comprise volume of void parameter of the nodes. Said volume of void parameters includes porosity for nodes representing porous matrix, either aperture or volume for nodes representing surface discontinuities, and radius or diameter, or volume, for nodes representing conduits.

Regarding nodes representing porous matrix, the updated parameters may comprise, in addition to porosity, the volume of the element represented by the node.

According to an embodiment, updating the aperture of a node representing a surface discontinuity may comprise computing a Δb_{F} corresponding to an aperture increase of the node, and adding said aperture increase to the previous aperture. Δb_{F} may be computed as follows:

$$Δ {b}_{{F}_{j}} = \frac{{v}_{{F}_{j}}}{{A}_{{F}_{j}}}$$

where A_{F}_{ⱼ} is the area of the surface discontinuity represented by the node.

Updating the radius of a node representing a conduit may comprise computing a Δᵣₖ corresponding to a radius increase of the node, and adding said radius increase to the previous radius. Δnₖ may be computed as follows:

$$Δ {r}_{k} = \frac{{v}_{{C}_{k}}}{2 π \cdot {r}_{k} \cdot {L}_{{C}_{k}}}$$

where L_{C}_{ₖ} is the length of the conduit represented by the node.

According to an embodiment, updating the porosity of a node representing porous matrix may comprise computing a ΔΦ, corresponding to a porosity increase of the node, and adding said porosity increase to the previous porosity. ΔΦ may be computed as follows:

$${ΔΦ}_{i} = \frac{{v}_{M , i}}{{V}_{Mi}}$$

Optionally, updating the porosity may also take into account the impact of the increase in diameter and aperture of the conduits and surfaces of the reservoir on the volume of the neighboring nodes corresponding to porous matrix. In this case the porosity increase may be rewritten into:

$${ΔΦ}_{i} = \frac{{v}_{{M}_{i}}}{{V}_{{M}_{i}} [ t + dt ]}$$

Where V_{M}_{ᵢ}[t+dt] corresponds to the previous matrix volume V_{M}_{ᵢ}[t] from which are deduced the volumes of corresponding to aperture increase and diameter increase of the neighboring nodes and surfaces.

The order in which the volume of void parameters corresponding to nodes belonging to respective media may not necessarily be the one presented above, and may be set by the user. For instance, according to another order, updating the parameters of the nodes may be performed according to the following order:
updating the radius of the nodes corresponding to conduits;
updating the aperture of the nodes corresponding to surface discontinuities; and
updating the porosity of the nodes corresponding to the porous matrix.

According to an embodiment, when the graph model has been obtained by conversion of a meshed model formed of a plurality of polyhedrons, the computation of the updated parameters may be performed by application of a mass balance, considering a given polyhedron, as follows.

With reference to FIG. 6, the total volume of a polyhedron Vp is the sum of the volume of the porous matrix of the node at the center of the polyhedron, a part of the volume of the surface discontinuities on the faces of the polyhedron and a part of the volume of the conduits on the edges of the polyhedron:

$${V}_{{P}_{i}} = {V}_{{M}_{i}} + {\sum }_{j = 1}^{jFi} {V}_{{F}_{j , i}} + {\sum }_{k = 1}^{kCi} {V}_{{C}_{k , i}}$$

where jFi is the number of nodes corresponding to discontinuities, connected to node i, and kCi is the number of nodes corresponding to conduits, connected to node i.

As mentioned above, the volume of the porous matrix V_{M}_{ᵢ} is composed of a volume of void V_{V}_{ᵢ} caused by porosity and a volume of rock V_{R}_{ᵢ};

$${V}_{{R}_{i}} = {V}_{{M}_{i}} \cdot ( 1 - {∅}_{i} )$$

$${V}_{{V}_{i}} = {V}_{{M}_{i}} \cdot {∅}_{i} + {\sum }_{j = 1}^{jFi} {V}_{{F}_{j , i}} + {\sum }_{k = 1}^{kCi} {V}_{{C}_{k , i}}$$

The volume of rock dissolved by a particle in a node corresponding to a porous matrix, v_{M}_{ᵢ}, directly corresponds to a volume of void that is created at the node.

Regarding dissolution within a conduit, the volume of rock dissolved by a particle in a node k, v_{C}_{ₖ}, enables computing an updated equivalent radius:

$${r}_{{eq}_{k}} [ t + dt ] = \sqrt{\frac{{V}_{{C}_{k}} [ t + dt ]}{π {L}_{{C}_{k}}}} = \sqrt{\frac{{V}_{{C}_{k}} [ t ] + {\sum }_{i = 1}^{iCk} \frac{{v}_{{C}_{k , i}}}{1 - {∅}_{i} [ t ]}}{π {L}_{{C}_{k}}}}$$

Moreover, as the conduit extends on an edge of a polyhedron, and that this edge may be shared by a number iCk of polyhedrons, the volume of rock

$${v}_{{C}_{{k}_{0}}}$$

dissolved by a particle at the node k₀ is distributed between the iCk polyhedrons according to their sensibility to dissolution, and according to the angle of the polyhedron at the edge corresponding to the conduit:

$${v}_{{C}_{{k}_{0} , i}} = \frac{{θ}_{i}}{2 π} {β}_{i} \cdot {v}_{{C}_{{k}_{0}}}$$

$$With$$

$${v}_{{C}_{{k}_{0}}} = {v}_{c} \frac{{V}_{{C}_{{k}_{0}}} \cdot {β}_{{k}_{0}} \cdot {DP}_{{k}_{0}}}{{\sum }_{k = 1}^{kmax} {V}_{{C}_{k}} \cdot {β}_{k} \cdot {DP}_{k}}$$

$$And$$

$${β}_{{k}_{0}} = \frac{1}{2 π} {\sum }_{i = 0}^{iCk} {β}_{i} {θ}_{i}$$

The fact that the polyhedra neighboring a conduit are not equally dissolved explains the wording “equivalent” radius employed above.

Regarding dissolution within a surface discontinuity, the volume of rock dissolved by a particle in a node j, v_{F}_{ⱼ}, enables computing an updated aperture:

$${b}_{{F}_{j}} [ t + dt ] = {b}_{{F}_{j}} [ t ] + \frac{1}{{A}_{{F}_{j}}} {\sum }_{i = 1}^{2} \frac{{v}_{{F}_{j , i}}}{1 - {∅}_{i} [ t ]}$$

Moreover, as a surface discontinuity extends between two polyhedrons, the volume of rock dissolved by a particle at the node j₀,

$${v}_{{F}_{{j}_{0}}}$$

is distributed between the two polyhedrons according to their sensibility to dissolution:

$${v}_{{F}_{{j}_{0} , {i}_{0}}} = {v}_{{F}_{{j}_{0}}} \cdot \frac{{β}_{{i}_{0}}}{{\sum }_{i = 1}^{2} {β}_{i}}$$

$$with :$$

$${v}_{{F}_{{j}_{0}}} = {v}_{F} \cdot \frac{{V}_{{F}_{{j}_{0}}} \cdot {β}_{{j}_{0}} \cdot {DP}_{{j}_{0}}}{{\sum }_{j = 1}^{jmax} {V}_{{F}_{j}} \cdot {β}_{j} \cdot {DP}_{j}}$$

$$and : {β}_{j} = \frac{1}{2} {\sum }_{i = 1}^{2} {β}_{i}$$

Therefore, considering a given polyhedron, the mass balance may be expressed as:

$${V}_{{M}_{i}} {∅}_{i} [ t + dt ] + {V}_{{M}_{i}} ( 1 - {∅}_{i} ) [ t + dt ] + {\sum }_{j = 1}^{jFi} {V}_{{F}_{j , i}} [ t + dt ] + {\sum }_{k = 1}^{kCi} {V}_{{C}_{k , i}} [ t + dt ] = {V}_{{M}_{i}} {∅}_{i} [ t ] + {V}_{{M}_{i}} ( 1 - {∅}_{i} ) [ t ] + {\sum }_{j = 1}^{jFi} {V}_{{F}_{j , i}} [ t ] + {\sum }_{k = 1}^{kCi} {V}_{{C}_{k , i}} [ t ]$$

Assuming that particles flowing within the conduits and surface discontinuities dissolve the porous matrix with its porosity at time t, the volume of the conduits associated with part of the conduit k within the polyhedron i at t+Δt equals:

$${V}_{{C}_{k , i}} [ t + dt ] = {V}_{{C}_{k , i}} [ t ] + \frac{{v}_{{C}_{k , i}}}{1 - {∅}_{i} [ t ]}$$

And the updated volume of the part of the surface discontinuity j within the polyhedron i at t+Δt equals:

$${V}_{{F}_{j , i}} [ t + dt ] = {V}_{{F}_{j , i}} [ t ] + \frac{{v}_{{F}_{j , i}}}{1 - {∅}_{i} [ t ]}$$

Last, the updated volume of the porous matrix can be computed as follows:

$${V}_{{M}_{i}} [ t + dt ] = {V}_{{M}_{i}} [ t ] - \frac{{\sum }_{j = 1}^{jFi} {v}_{{F}_{j , i}} + {\sum }_{k = 1}^{kCi} {v}_{{C}_{k , i}}}{1 - {∅}_{i} [ t ]}$$

And one can infer an updated porosity of the node corresponding to the porous matrix:

$${∅}_{i} [ t + dt ] = {∅}_{i} [ t ] + \frac{{v}_{{M}_{i}}}{{V}_{{M}_{i}} [ t + dt ]}$$

From said updates, an updated permeability may be computed for each node, for instance by application of the equation relating porosity and permeability provided above.

Again, the order of updating the parameters of the various media is not necessarily the one that has been presented above.

Once the parameters of the nodes have been updated, the step of simulating dissolution preferably comprises updating 440 the transmissibility values of the connections of the graph according to the updated parameters.

The method may then comprise a step 500 of updating the topology of the graph model when a parameter of at least one node satisfies a predefined condition.

In embodiments, updating the topology of the graph may comprise suppressing at least one node when a parameter of the node satisfies a predefined condition. The suppression of a node also includes suppressing the connections between the suppressed nodes and the adjacent nodes. Moreover, new connections may be created between two nodes that were both initially connected to the suppressed node.

In embodiments, when a node is suppressed, a volume of void corresponding to the node may be distributed among at least some of the nodes to which it was connected.

For example, as explained above, dissolution may cause an increase in volume of surface discontinuities or conduits. When a node corresponding to a conduit is connected to a node corresponding to a surface discontinuity, it is considered that the conduit no longer exists individually if its diameter becomes smaller than the aperture of the surface discontinuity to which it is connected.

Therefore, when the aperture of a node corresponding to a surface discontinuity exceeds the diameter of a node corresponding to a conduit, and to which the former is connected, then the node corresponding to the conduit is disabled, as well as its connections to other nodes.

Furthermore, the parameters associated with the node corresponding to the conduit are updated in order to integrate the volume of void, represented by the conduit, which has been deleted. An updated volume is computed as the sum of the previous volume of the surface discontinuity and the volume of the deleted node, and an updated aperture is inferred from said updated volume.

According to another example, as described above the volume v_{Mi} of the porous matrix of a node corresponding to said porous matrix may be reduced because of the increase in volume of neighboring conduits or surface discontinuities. Updating the topology of the graph model then comprises suppressing the node corresponding to the porous matrix when the volume v_{Mi} of the porous matrix decreases below a determined threshold. In embodiments, this threshold may be defined as a determined percentage of the initial volume of the porous matrix or a minimum porous matrix volume.

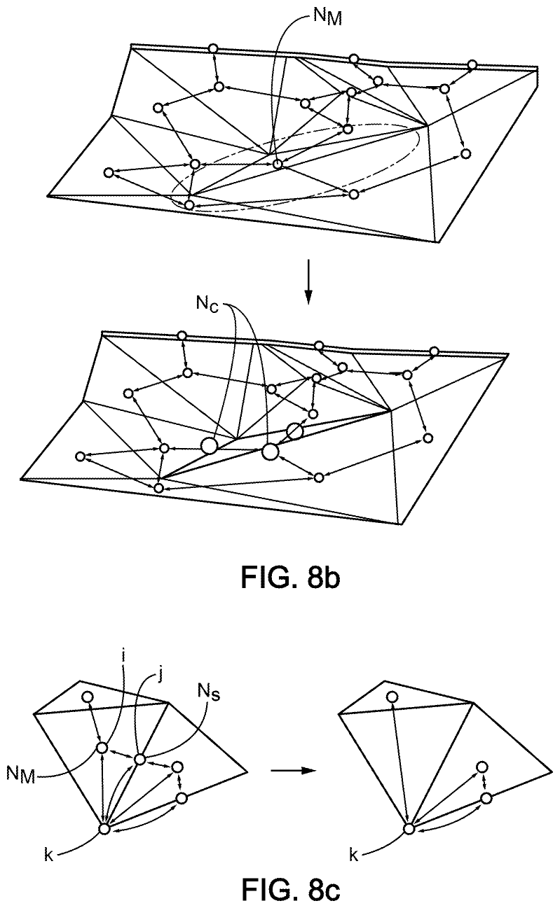

As shown in the schematic example shown in FIG. 8a, a node corresponding to the porous matrix is suppressed, as well as its connections to adjacent nodes of the graph, and new connections are established between the nodes of the graph that were formerly connected to the suppressed node.

The volume of void of the deleted node (v_{Mi}, Φᵢ) is distributed to the nodes corresponding to conduits or surface discontinuities to which it was connected. The distribution among a plurality of conduits may be proportional to the lengths of the conduits. The distribution among a plurality of surface discontinuities may be proportional to the surfaces of the surface discontinuities. Last, the distribution among nodes comprising nodes corresponding to surface discontinuities and nodes corresponding to conduits may respect a previous permeability contrast between the conduits and the surface discontinuities. Therefore for each node corresponding to a conduit or a surface discontinuity that was connected to the deleted node, an updated volume is computed from the addition of the part of the volume of void of the deleted node, and an updated radius or aperture can also be derived from the updated volume.

According to still another example, as described above the fluid flow within the porous matrix causes increase of porosity in the corresponding nodes. Thus, when the porosity of a node corresponding to the porous matrix exceeds a predetermined threshold, the node is suppressed as well as its connections to adjacent nodes.

In embodiments, two different thresholds may be defined, depending on whether or not the node is connected to at least a node that represents a conduit or a surface discontinuity.

If the node of porous matrix is connected to at least a conduit or a surface discontinuity, then the porosity threshold may be lower than if the node of porous matrix is not connected to a conduit or a surface discontinuity, given the opportunity for the remaining material to be flushed through the conduit or the surface discontinuity.

Further, when the node of porous matrix is connected to at least a conduit or a surface discontinuity, and the corresponding porosity threshold is reached, updating the topology of the graph model comprises deleting the node corresponding to the porous matrix and its connections to adjacent nodes, and distributing the volume of void of the deleted node to the conduits and the surface discontinuities to which it was connected, in proportions as indicated above.

With reference to FIG. 8b, when the node of porous matrix is not connected to a conduit or a surface discontinuity, and the corresponding porosity threshold is reached, updating the topology of the graph model comprises:

deleting the node corresponding to the porous matrix and its connections to adjacent nodes and and further activating the initially inactive nodes adjacent to the deleted node, that correspond to conduits and were initialized with a null volume and a null permeability, by distributing the volume of void of the deleted node to them.

For each activated node, a non-null radius can then be computed from the part of the volume of void which has been distributed. The permeability can then be derived from the radius, as well as a transmissibility value of the connection of each activated node to the adjacent nodes.

Last, with reference to FIG. 8c, when a node corresponding to the porous matrix is suppressed, and when said node was connected to a surface discontinuity, the updating of the topology of the graph further comprises suppressing the node corresponding to the surface discontinuity as well as its connections. The volume of void associated with the suppressed nodes, i.e., the volume of the porous matrix and the volume of the surface discontinuity, is then added to the volume of the conduits, whether active (i.e., with non-null volume or permeability) or inactive (i.e., with an initial null volume and permeability) and the diameter of the node or nodes corresponding to the conduit(s) neighboring the node corresponding to the porous matrix is updated to reflect this increase of volume.

After the parameters of the nodes have been updated, the transmissibility values of the connections between the nodes are updated accordingly.

In preferred embodiments, the steps of simulating dissolution over a period of time and updating the topology of the graph model are iterated repeatedly. Preferably, the steady state flow field is recomputed 300 prior to each new occurrence of the simulation step, in order to adapt the flow field to the updated values of transmissibility between the nodes and to the updated topology of the graph. For instance, the activation of new nodes corresponding to conduits, or the deletion of nodes may have a strong impact in the next computation of the flow field.

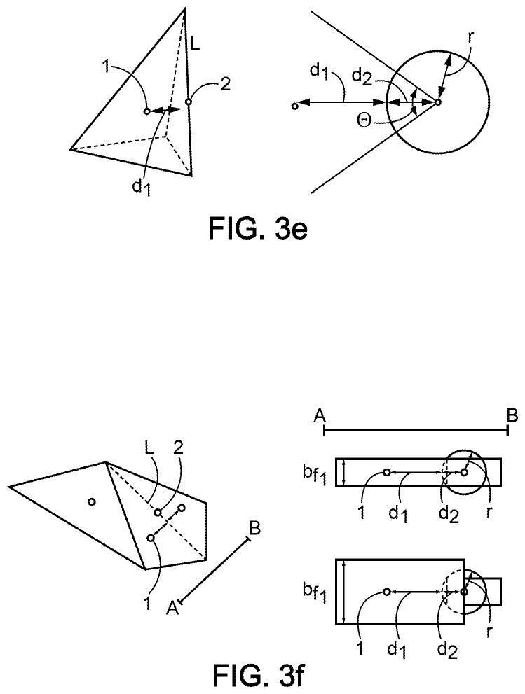

This in turn changes the flow path of the particles during step 400. In particular, and as shown in FIGS. 4a and 4b schematically representing the evolution, over successive iterations, of the flow field within a reservoir having a conduit at a center thereof, which permeability is greater than the permeability of the neighboring matrix, it can be observed that the dissolution process progressively increases the diameter of the conduits and the aperture of the surface discontinuities, leading to increased transmissibility between nodes of conduits and surface discontinuities and increased flow within the conduits and the surface discontinuities. Optionally, the definition 200 of the flow boundary conditions may also be amended before an iteration of step 300.

In embodiments, after at least one iteration or after a series of consecutive iterations, the updated parameters of the graph model may be used to update the three-dimensional meshed model from which the graph has been generated, and to display 600 a graphical representation of the updated meshed model. Indeed, as the meshed model conforms to surface discontinuities and conduits, it is easier for an operator to understand the disposition and size of said surface discontinuities and conduits, and to compare them with a different state, for instance a previous state, than by analyzing or visualizing a graph.

For example, when new conduits have appeared within the graph, or surface discontinuities have increased in aperture, this can be apparent in the displayed 3D meshed model.

According to another non-limiting example, the increase in diameter or aperture may be displayed using a specific color denoting respectively an increase; a decrease, or an increase within a determined, or a decrease within a determined range. According to another example, specific colors may be associated with determined ranges of diameter or aperture, enabling to differentiate visually the conduits and surface discontinuities according to their size. The updated diameters of the conduits or updated apertures of the surfaces may also be displayed visually, for instance by the thickness of the line or shape representing the conduit or aperture. Moreover, it is also possible to display only the network of conduits and/or the network of surface discontinuities, i.e., without the parts of the meshed model representing the porous matrix.

The various embodiments described above can be combined to provide further embodiments. All of the patents, applications, and publications referred to in this specification and/or listed in the Application Data Sheet are incorporated herein by reference, in their entirety. Aspects of the embodiments can be modified, if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A computer-implemented method for simulating the evolution of a reservoir due to dissolution within the reservoir, comprising:
representing the reservoir by a graph model comprising a plurality of nodes and connections between the nodes, wherein each node is associated with at least one geological parameter;
simulating dissolution induced by a fluid flowing through the reservoir during a determined time period, wherein said simulating comprises computing updated values of geological parameters assigned to the nodes of the graph model as a consequence of said dissolution; and
updating a topology of the graph model when a parameter of a node of the graph model satisfies a predefined condition.

2. The method according to claim 1, wherein updating the topology of the graph model comprises suppressing a node when a parameter of the node satisfies a predefined condition.

3. The method according to claim 2, wherein updating the topology of the graph model further comprises generating new connections between the nodes that were previously connected to the suppressed node.

4. The method according to claim 2, wherein each node is associated with at least a volume of void parameter, and updating the topology of the graph model comprises distributing the volume of void of the suppressed node to the nodes to which the suppressed node was connected.

5. The method according to claim 1, wherein the graph model represents at least two geological media, comprising a first medium corresponding to a porous matrix, and at least another medium corresponding to surface discontinuities or conduits within the porous matrix,
wherein each node of the graph model corresponds to a selected one among the at least two media, and the connections between the nodes include connections between two nodes corresponding to the same medium and connections between nodes corresponding to any two different media.

6. The method according to claim 5, wherein the nodes are associated with volume parameters, and simulating dissolution comprises increasing the volume of at least one node corresponding to conduits or surface discontinuities, the method further comprising reducing the volume of porous matrix of at least one node corresponding to the porous matrix, wherein updating the topology of the graph model comprises suppressing a node corresponding to the porous matrix when its volume decreases below a determined threshold.

7. The method according to claim 1, wherein the nodes are associated with parameters including at least a volume of void parameter, simulating dissolution comprises updating the volume of void parameter of some nodes as a consequence of dissolution, and the topology of the graph model is updated when the volume of void parameter of a node satisfies a predefined condition.

8. The method according to claim 7, wherein the graph model represents at least two geological media, comprising a first medium corresponding to a porous matrix, and at least another medium corresponding to surface discontinuities or conduits within the porous matrix,
wherein the volume of void parameter associated with nodes corresponding to conduits or surface discontinuities comprise a transverse dimension of the conduits or the surface discontinuities, and updating the topology of the graph model comprises suppressing a node corresponding to a conduit when said node is connected to a node corresponding to a surface discontinuity and the updated transverse dimension of the surface discontinuity is greater than the updated transverse dimension of the conduit.

9. The method according to claim 7, wherein the volume of void parameter associated with nodes corresponding to the porous matrix includes a porosity, and updating the topology of the graph model comprises suppressing the node corresponding to the porous matrix if its porosity exceeds a predetermined porosity threshold.

10. The method according to claim 7, wherein the graph model represents a medium corresponding to conduits within the porous matrix, and updating the topology of the graph model further comprises activating new conduits within the graph model.

11. The method according to claim 1, wherein the graph model represents three geological media comprising a porous matrix, surface discontinuities within the porous matrix, and conduits within the porous matrix, and representing the reservoir by a graph model comprises generating the graph model from a three-dimensional meshed model representing the reservoir, the three-dimensional meshed model comprising a plurality of three-dimensional polyhedrons conforming to the surface discontinuities and conduits of the reservoir,
wherein a surface discontinuity is represented by a two-dimensional (2D) meshed surface where each cell of the surface is a face of a three-dimensional (3D) polyhedron, and each conduit is represented by a one-dimensional (1D) meshed line where each cell of the line is an edge of a 3D polyhedron,
the generation of the graph model comprising:
generating nodes corresponding to the porous matrix at the center of each polyhedron;
generating nodes corresponding to the surface discontinuities at the center of each face of a polyhedron forming a 2D meshed surface representing a surface discontinuity;
generating nodes corresponding to the conduits at the center of each edge of a polyhedron corresponding to a conduit; and
generating connections between two adjacent nodes.

12. The method according to claim 11, wherein the graph model represents a medium corresponding to conduits within the porous matrix, and updating the topology of the graph model further comprises activating new conduits within the graph model,
wherein the generation of the graph model further comprises generating additional nodes at the center of each edge of polyhedron that does not belong to a conduit, said additional nodes being initially inactive, with a null volume of void,
and activating new conduits within the graph model comprises updating the permeability of additional nodes to a non-null value.

13. The method according to claim 12, wherein updating the permeability of the node to a non-null value comprises distributing some volume of void of suppressed nodes corresponding to the porous matrix to the nodes corresponding to inactive conduits adjacent to the suppressed nodes.

14. A non-transitory computer-readable storage medium having stored thereon code instructions which when executed by a computer, cause said computer to implement the method according to claim 1.

15. A computing device comprising at least a memory and a circuit configured to implement the method according to claim 1.
